(19) United States
(12) Patent Application Publication
(10) Pub. No.: US 2013/0174880 A1
(43) Pub. Date: Jul. 11, 2013

(54) MULTI-FUNCTIONAL CLEANING ROBOT

(71) Applicants: Ludwig Clusserath, Bad Kreuznach (DE); Udo Grunewald, Weiler (DE)

(72) Inventors: Ludwig Clusserath, Bad Kreuznach (DE); Udo Grunewald, Weiler (DE)

(73) Assignee: KHS GmbH, Dortmund (DE)

(21) Appl. No.: 13/822,445

(22) PCT Filed: Aug. 26, 2011
(86) PCT No.: PCT/EP2011/004295

§ 371 Date: Mar. 12, 2013

(30) Foreign Application Priority Data
Sep. 14, 2010 (DE) 10 2010 045 268.8

(51) Int. Cl. B08B 9/20

(52) U.S. Cl. CPC B08B 9/205
USPC 134/142

(57) ABSTRACT

A container treatment device includes a container-feeding unit, a container removing unit, a feed line for a product, and a cleaning device. The cleaning device includes either a flushing device for cleaning an exterior surface using a cleaning fluid or an additional tool that can be removed from a storage device by the cleaning device and that can be brought to a position of use and returned to the storage device after use by the cleaning device.

The invention relates to a container treatment device, especially filler, capper/seamer or rinser, for containers, such as bottles, cans, barrels, kegs, etc., comprising a container feeding unit, a container removing unit, at least one feed line for at least one product, and a cleaning device having a flushing device at least for cleaning the exterior surfaces by means of a cleaning fluid.

Such machines for treating containers, such as bottles, cans or barrels, especially kegs, are known. In general, one machine serves for one treatment step. Particularly when rinsing, filling and capping containers, machine and container surfaces are contaminated from outside by overflowing charge or splashes of charge. The surrounding room is also a source of soiling, so that dust, particles, etc. adhere to the moist machine and container surfaces.

In order to remove this soiling, nozzle systems are provided which flush away the soiling. U.S. Pat. No. 7,143,793 B2 discloses such a system, in which a stationary nozzle block is arranged in front of the rotating filling machine, said nozzle block having nozzles directed radially in the direction of the filler axis as well as a nozzle arm which protrudes between the filling valve and the container holder and the nozzles of which are directed vertically upwards.

EP 0 374 586 B1 discloses a cleaning unit for a linear filler, in which a cleaning carriage which is equipped with a plurality of nozzles can be displaced back and forth horizontally on a rail in the interior of the filler.

These devices, which are suitable in principle, have the disadvantage that a high volume of water and cleaning agent is required in order to ensure a sufficiently large flush of fluid that reaches all the surfaces to be cleaned.

It is also known that components, internal pipelines, valves, etc. of the cleaning device must themselves be cleaned in order to meet the high sterility requirements. If this was not the case, germs or the like could build up for example in filling elements which may come into contact with the containers, so that the charge would thus be contaminated.

To this end, use is made of so-called rinsing caps or rinsing sleeves which seal off the respective filling element from the surrounding environment in a pressure-tight manner, so that a circuit-type flow of the cleaning medium can be used to clean the filling element.

Such rinsing caps are disclosed for example in DE 10 2005 037 127 A1. Rinsing caps are also disclosed in DE 103 56 393 A1, DE 20 2004 020 362 U1, DE 20 2006 006 140 U1, DE 295 14 021 U1, DE 39 18 504 C2, DE 44 02 972 A1 and for example in DE 94 03 832.

In principle, the use of rinsing caps is useful in order to meet, as already mentioned, the high sterility requirements. One disadvantage, however, is the considerable effort involved in installing and maintaining the rinsing caps, which in a rest position must be stored in such a way that the normal operation of the container treatment device is not disrupted. In order to be brought from the rest position into an operating position, separate drives are arranged for example on each rinsing cap (DE 20 2004 020 362 U1) or, as described in DE 44 02 972 A2, a linear conveyor is provided which conveys the rinsing caps into the working area and also away again therefrom, wherein a region of the drives or of the linear conveyor enters the working area of the container treatment device.

The container treatment devices are therefore provided with separate cleaning devices, namely on the one hand for cleaning the exterior surfaces of containers and/or exterior surfaces of the machine components and on the other hand for cleaning the filling elements by means of the rinsing caps. This signifies a high cost, particularly when manufacturing the container treatment device, but also a high outlay on control elements since the separate cleaning devices can be actuated separately from one another, wherein in particular the cost of using the rinsing caps is considerable.

Moreover, after use, i.e. once the cleaning of the filling elements is complete, the rinsing sleeves must be conveyed out of the container treatment device with considerable effort, or at least brought to a location at which the rinsing caps themselves can be cleaned. The rinsing caps can thus be used multiple times, but the effort required for this is nevertheless very considerable.

The problem addressed by the invention is therefore that of improving a container treatment device of the type mentioned in the introduction using simple means, so that for example the effort for cleaning also the filling elements can be reduced.

According to the invention, the problem is solved by a container treatment device having the features of claim 1.

It is advantageous that, in addition to the flushing device or instead of the same, an additional tool can be connected to the cleaning device, which tool can be removed from a storage device by the cleaning device and can be brought into a position of use and returned to the storage device after use by the cleaning device.

The essence of the container treatment device lies in a track running around all or part of the circumference, and a drive and support rail on which a robot or robot arm can be displaced. The track should be provided around the treatment device at least in such a way that all the exterior surfaces of a container treatment device but also the surfaces of the containers can be reached and cleaned in an optimal manner.

With this cleaning device, which consists essentially of the robot or robot arm and the drive and support rail as well as associated supply lines, any position on a container treatment machine or device can be approached very quickly and can be flushed in an absolutely precise manner with a minimal consumption of water and cleaning agent. The robot or robot arm has at least two, ideally six, axes and is telescopically height-adjustable with at least one arm segment. Due to the high travelling speeds, this cleaning system is able to use even brief stoppages in operation to clean parts or individual components of the container treatment plant or device. In particular, using the cleaning device, it is possible to perform small-area cleaning operations after replacing parts, which is in turn advantageous from an energy and cost point of view.

The cleaning device, in particular the robot or robot arm, is now advantageously further developed so that not only can it flush the exterior surfaces of the containers and of the machine, for which purpose the flushing device may be configured for example as a spray nozzle or spray gun, but for example it can also pick up rinsing caps and places these on the filling elements so that the latter can be cleaned in a known manner.

The robot or robot arm can therefore pick up a spray gun for cleaning for example the exterior surface of the containers and of the machine components, and can perform, as it were, a tool change in order to pick up the rinsing caps. However, it is also conceivable to place on the drive and support rail an additional robot or robot arm which brings the rinsing caps into their position of use. It is also possible to provide on the actual robot or robot arm an additional gripper and/or an additional holder which can bring the rinsing cap into its position of use.

In the invention, it is advantageous that the storage device in a preferred configuration as a rinsing cap magazine can be provided on a vertical outer wall in the region of a casing of the container treatment device, which can advantageously be achieved by the possibility for displacement created by the “track guidance” of the robot or robot arm on the track, i.e. on the drive and support rail. Advantageously, the rinsing cap magazine or the storage device is arranged in such a way that a distance for bringing the rinsing caps from the magazine into their position of use is as small as possible.

If the rinsing caps are stored on the rinsing cap magazine and are brought back into their rest position after use, which can advantageously also be carried out by the at least one robot or robot arm, the possibility can thus be provided that the robot or robot arm can clean directly these rinsing caps stored in the rinsing cap magazine. The rinsing caps therefore do not need to be brought to different locations after use but rather can advantageously be cleaned by the robot or robot arm directly on the container treatment device or in the working area of the latter, for which purpose suitable spray nozzles are provided which can likewise be used for cleaning for example the container surfaces.

It is also advantageous if the different tools (spray gun/rinsing cap) can be connected to the robot or robot arm by a connection system such that the spray gun or spray nozzle can be reliably connected in an appropriate manner, wherein the rinsing cap need only be reliably held in such a way that a reliable connection to the filling element can be established, for which purpose suitable locking devices may be provided which will be further described below.

The rinsing cap magazine, in the simplest configuration as a steel sheet or plastic panel, can be designed with insertion openings therein, in which the rinsing caps are stored in such a way that they can be picked up in their installation position and can be inserted back into the rinsing cap magazine in their rest position. It is advantageous if an appropriate locking device, for example a pneumatic lock for the respective rinsing cap, is provided on the filling element. The robot or robot arm can thus simply remove the rinsing cap from the storage device and simply position and lift it onto the filling element or onto the filling valve, wherein the controlled or automatic locking can take place in the lifted state. Said pneumatic lock can thus of course be understood to be merely an example, other suitable, controllable locking devices or even simple mechanical locking and unlocking devices also being encompassed.

The cleaning device with the robot or robot arm preferably running around the circumference or with the cleaning robot running around the circumference thus has at least a dual function. On the one hand, the cleaning of surfaces and machine components is brought about by flushing. On the other hand, the use and return of rinsing caps can be effected in a simple manner. The advantage of the invention is therefore clear in terms of a complex system which can carry out different functions without particularly complicated measures having to be provided. The cleaning device or the cleaning robot can moreover also perform the cleaning of the rinsing caps, so that the cleaning robot is multi-functional. The process of cleaning the rinsing caps can advantageously take place together with the cleaning of said (exterior) surfaces.

It is advantageous that the rinsing caps can be stored in such a way that the robot or robot arm can pick up and accordingly set down these rinsing caps automatically, i.e. when actuated accordingly, which can of course also apply to the spray nozzles for cleaning said surfaces. Advantageously, therefore, no staff are required for the multi-functionality of the cleaning device since all the functions can preferably be effected automatically, without manual intervention.

In one preferred embodiment, the rinsing cap is attached to the robot arm by suction. To this end, the pumps which serve for conveying the cleaning agent are configured in such a way that a reversal of the conveying direction is possible. As an alternative to this, a separate vacuum system can be provided in order to be able reliably to hold and transport the rinsing caps without the need for a mechanical gripper.

Ideally, the rinsing caps have a pin-shaped or bolt-shaped gripping region which can to this end be picked up in a suitable opening or line end on the robot arm, as a result of which an optimal given orientation of the rinsing cap is achieved. Once the rinsing cap has been positioned on the valve outlet on the filler, said rinsing cap is ideally released from the fixing on the robot arm by a flow reversal or a pressure equalisation.

In one further development of the invention, it may advantageously be provided that the robot or robot arm can moreover pick up further tools or components in addition to those mentioned previously by way of example. For example, it is conceivable that an inspection unit can be picked up, which then inspects the container treatment device. Thus, for example, a state of the container treatment device, even during ongoing operation, can be monitored with regard to pending maintenance, without a member of staff having to enter the working area of the container treatment device. Instead, this can take place directly from a central machine control station, particularly if the inspection unit transmits its data wirelessly, but also via wires, to appropriate receivers. The inspection unit may be configured for example as a camera which, when necessary, can be gripped and positioned by the robot arm and the images of which can be viewed directly or a screen or can optionally be stored for later use.

The robot or robot arm can therefore be equipped with a further function which makes it possible to carry out an inspection in which an opening of or access to the container treatment device can be avoided. Of course, other suitable tools can also be used by the cleaning device according to the invention in order beneficially to supplement the functionality thereof.

It is also advantageous if the circumferential track has at least one rest area in which the at least one robot or robot arm, but also additional robots or robot arms, can be parked, so that in this area a tool change can be carried out, which of course can also take place on the track itself in suitable areas of the container treatment device. Advantageously, for example, the tool “inspection unit” could be picked up in the rest area, wherein the storage device with the “rinsing cap” tools stored therein should advantageously be arranged sufficiently close to the filling elements, i.e. inside the container treatment device as it were, but sufficiently outside the working area thereof.

Further advantageous embodiments of the invention are disclosed in the dependent claims and in the following description of the figures, in which:

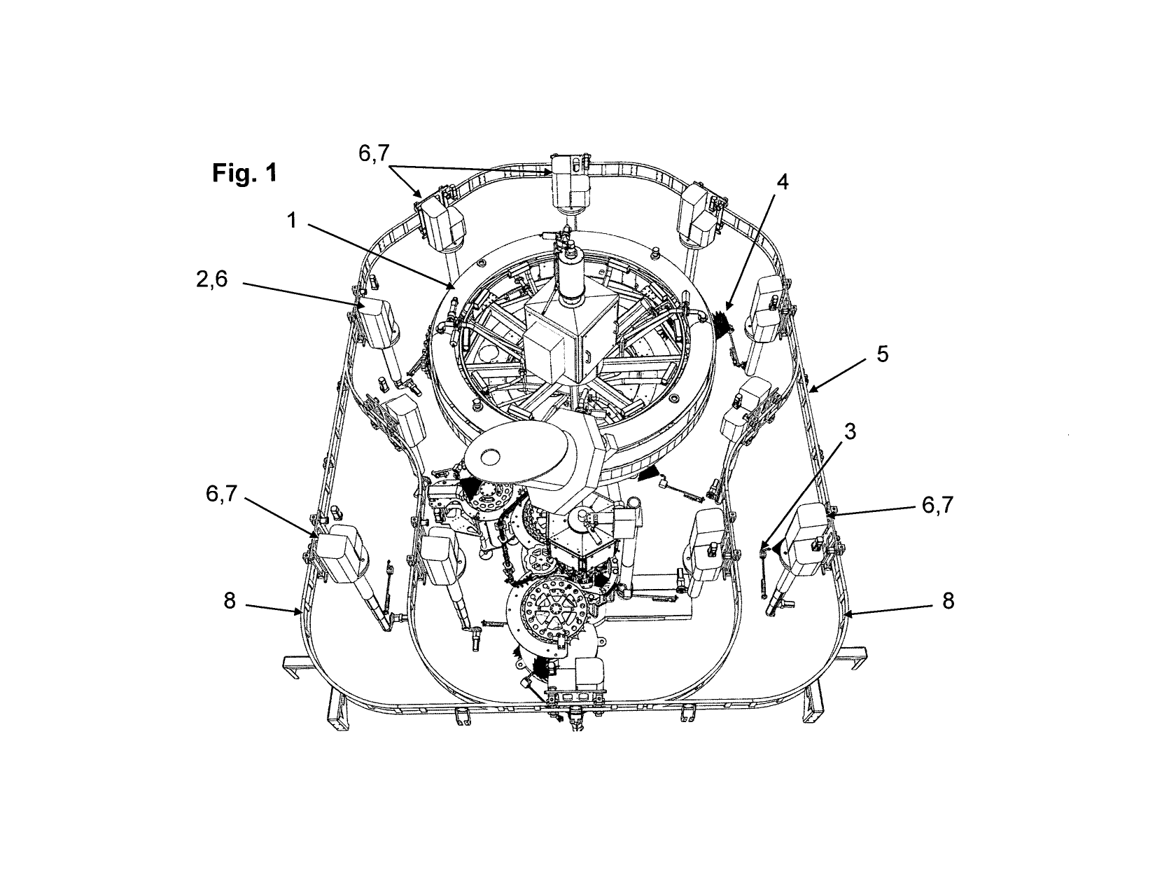

FIG. 1 shows a container treatment device in a perspective view,

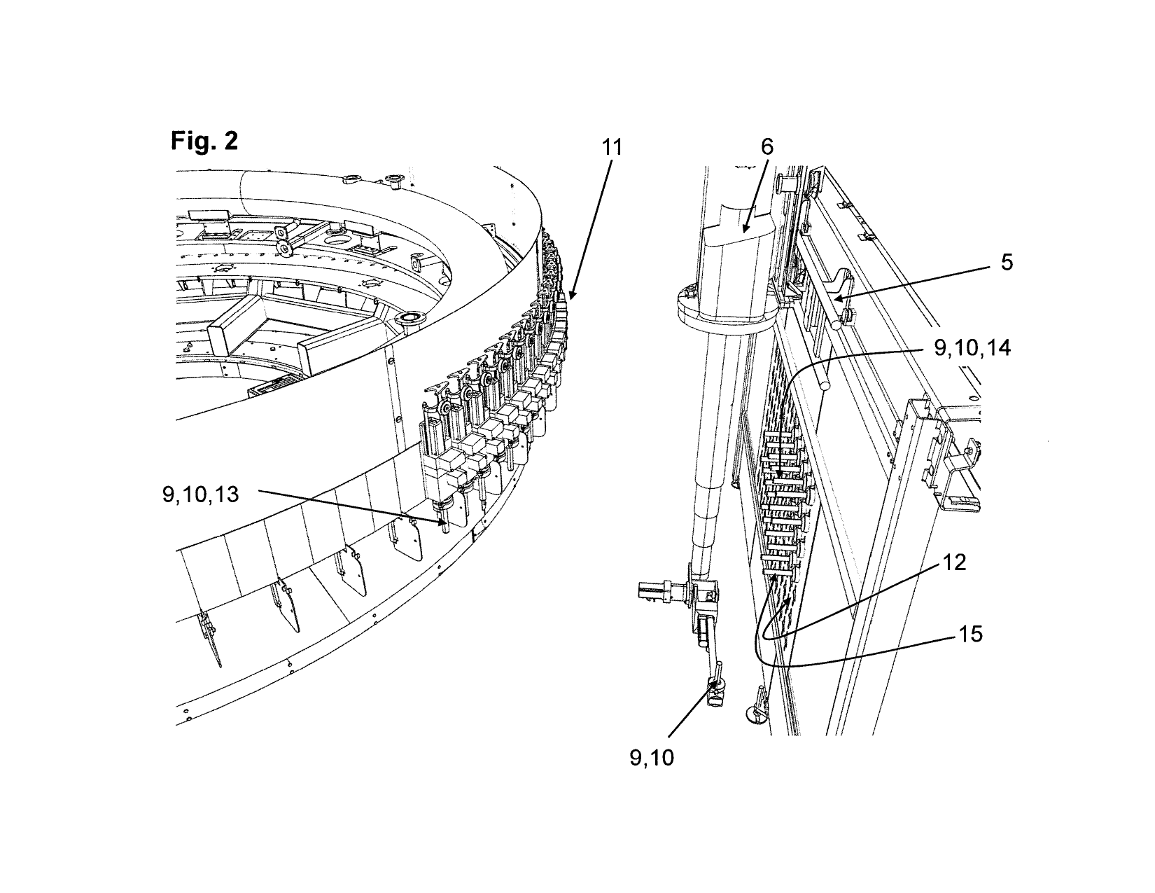

FIG. 2 shows a detail of the container treatment device from FIG. 1, regarding the use of rinsing caps or rinsing sleeves, and

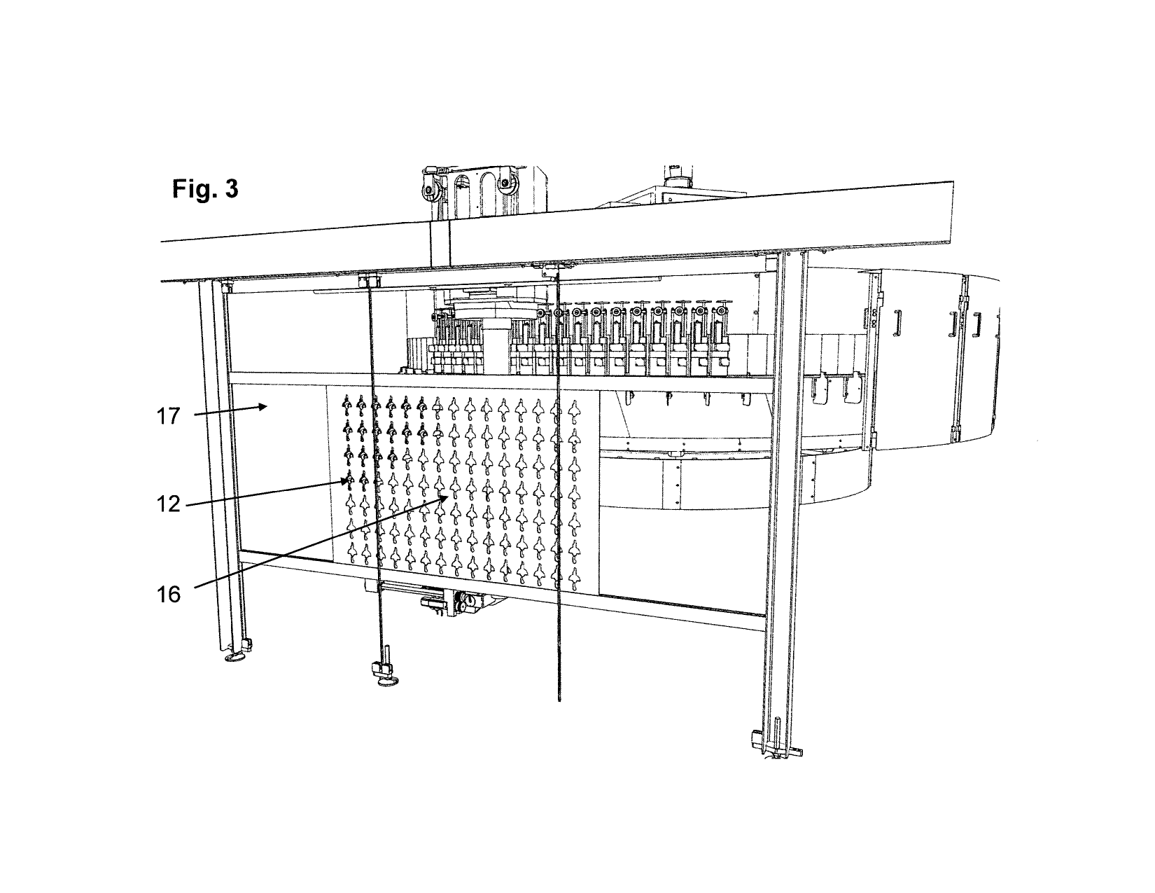

FIG. 3 shows the detail from FIG. 2 in a rear view of a storage device.

In the different figures, identical parts are generally provided with the same references, and for this reason will also be described only once.

FIG. 1 shows a container treatment device 1, by way of example as a filler, for containers, such as bottles, comprising a container feeding unit, a container removing unit, at least one feed line for at least one product, and a cleaning device 2 having a flushing device 3 at least for cleaning the exterior surfaces by means of a cleaning fluid 4, wherein the container feeding unit, the container removing unit and the at least one feed line for at least one product are in each case not provided with a reference.

The cleaning device 2 has a drive and support rail 5, on which a robot 6 or robot arm 6 can be displaced, so that as it were a track which runs around the entire circumference is formed. In this case, the track should be provided around the treatment device 1 at least in such a way that all the exterior surfaces of the container treatment device 1 but also the surfaces of the containers can be optimally reached and cleaned.

In FIG. 1, just one robot 6 or robot arm 6 is shown, but this is shown in different positions 7 along the drive and support rail 5. Of course, it is also possible for a plurality of robots 6 or robot arms 6 to be provided.

It can also be seen in FIG. 1 that at least one rest area 8 is provided, two rest areas 8 being provided in the example of embodiment shown in FIG. 1, which rest areas can be connected in a suitable points-type configuration to the actual track so that the robot 6 or robot arm 6 can move into and out of the respective rest area and can be parked therein, or in order to undertake a function other than the cleaning function, as will be discussed below.

The flushing device 3 is configured for example as a spray nozzle or spray gun, and is arranged in a suitable manner on the robot 6 or robot arm 6, although this will not be further discussed.

It is advantageous that the cleaning device 1, or the robot 6 or robot arm 6 shown in the example of embodiment, can perform at least one function in addition to the cleaning.

To this end, the cleaning device 1, particularly the robot 6 or robot arm 6 thereof, can be connected to a tool 9 in addition to the actual cleaning tool, i.e. in addition to or instead of the flushing device 3 (spray nozzle/spray gun). In a first embodiment, the additional tool 9 may be configured for example as a rinsing cap 10 or rinsing sleeve 10, which can be used in a known manner for cleaning filling elements 11 (FIG. 2). The additional tool 9 or the rinsing cap 10 is preferably stored in a storage device 12 in such a way as to be able to be removed from the latter and to be able to be brought by the cleaning device 1 or by the robot 6 or robot arm 6 into a position of use 13 and back into the storage device 12 after use.

If the additional tool 9 is configured as a rinsing cap 10, it is advantageous in the context of the invention to position the storage device 12 relatively close to the filling elements 11, so that a respective movement path into and out of the position of use 13 is as short as possible, wherein no impairments to operation are to be expected during normal operation of the container treatment device 1.

As can be seen from FIG. 2, the storage device 12 is arranged in the direct vicinity of the filling elements 11.

Arranged in the storage device 12 are a large number of additional tools 9 or rinsing caps 10, some of which are already arranged in the position of use 13 on the filling elements 11 and some of which are still in a rest position 14 in the storage device 12. One of the rinsing caps is held on the robot 6 or robot arm 6.

In order to bring the additional tool 9 or the rinsing caps 10 into the position of use 13 and back into the rest position 14, suitable gripping devices may be provided for example on an additional arm. However, it is also conceivable that the additional tool 9 is picked up instead of the flushing device 3. In principle, the tool change or the pick-up of the additional tool 9 can be carried out in a fully automatic manner, that is to say without manual intervention.

In one possible embodiment, the rinsing cap 10 is attached to the robot 6 or robot arm 6 by suction. To this end, pumps which serve for conveying the cleaning agent may be configured in such a way that a reversal of the conveying direction is possible. As an alternative to this, a separate vacuum system may be provided in order to be able reliably to hold and transport the rinsing caps without the need for a mechanical gripper.

In one preferred embodiment, the additional tool 9 has a pin-shaped or bolt-shaped gripping region 15 which can to this end be picked up in a suitable opening or line end on the robot 6 or robot arm 6, as a result of which an optimal given orientation of the rinsing cap is achieved. Once the rinsing cap has been positioned on the valve outlet on the filler or on the filling element 11, said rinsing cap is ideally released from the fixing on the robot 6 or robot arm 6 by a flow reversal or a pressure equalisation.

The storage device 12 (FIG. 3) is panel-shaped with insertion or receiving openings 16. It is conceivable to make the storage device 12 from a metal sheet, preferably from a stainless steel sheet, or from a plastic. The receiving openings 16 are advantageously configured in such a way that the additional tool 9 or the rinsing cap 10 can be securely stored therein in the rest position 14.

It can be seen in FIG. 3 that the storage device 12 is arranged within a working area of the container treatment device 1, that is to say between a housing 17 or protective wall 17 or casing 17 and the container treatment device 1, preferably below the drive and support rail 5. The casing 17 may, as shown, be transparent. This figure shows the further advantage of the invention, that the additional tool 9 or the rinsing cap 10 can be cleaned by means of the flushing device 3 either when the additional tool 9 is held on the robot 6 or robot arm 6 in order to clean the inner region of the rinsing cap 10 which in the position of use 13 encloses the filling element 11, or when the rinsing cap 10 is stored in the storage device 12 in the rest position 14. To this end, the rinsing cap could first be stored by its gripping region 15 in the storage device 12 in such a way that the inner region of the rinsing cap 10 or the “rinsing region” thereof located opposite the gripping region 15 is oriented towards the inside of the container treatment device 1, so that the rinsing cap(s) can be cleaned here not only from the inside but also from the outside. The rinsing caps 10 can then of course again be gripped by the robot 6 or robot arm 6 and stored in the intended rest position 14 in which the gripping region 15 is oriented towards the inside of the container treatment device 1, wherein the gripping region 15 could then additionally be flushed.

In a further advantageous embodiment, the cleaning device 2 or the robot 6 or robot arm 6 may be provided with a further function, to which end for example an inspection unit as an additional (further) tool 9 can be brought into a position of use. As the inspection unit, a camera for example could be connected in a suitable manner to the robot 6 or robot arm in order to inspect the container treatment device 1 without access from outside, to which end the robot 6 or robot arm 6 can be displaced along the drive and support rail 5 in order to obtain information that is as comprehensive as possible, for example regarding necessary maintenance works.

The inspection unit can transmit its recorded data preferably wirelessly to a receiver, so that an inspection can be carried out for example in a control station of the container treatment device 1 without there being any need to open the housing of the container treatment device 1.

The inspection unit can be stored at a suitable location in an appropriately designed storage device. For example, it is conceivable to provide one of the two rest areas 8 or both rest areas 8 for this purpose.

Of course, the inspection unit can also be sufficiently reliably connected to and then detached from the cleaning device 2 or the robot 6 or robot arm 6 automatically without any manual intervention.

The invention therefore provides a multi-functional cleaning device 2, or the robot 6 or robot arm 6 thereof, which in addition to the actual cleaning function can also perform further additional functions. With regard to the additional function of using the rinsing caps, the advantage can be seen that the effort involved in cleaning the filling elements is considerably reduced since this is possible via a fully automatic tool change using a common tool carrier (robot 6 or robot arm 6). Moreover, the rinsing caps can be cleaned by the common tool carrier after use. In addition, the common tool carrier can additionally perform an inspection function. Of course, said additional functions are not intended to be limiting. It is conceivable to provide suitable further useful functions.

### LIST OF REFERENCES

1 container treatment device
2 cleaning device
3 flushing device
4 cleaning fluid
5 drive and support rail
6 robot/robot arm
7 positions of 6 along 5
8 rest area
9 additional tool
10 rinsing cap as 9
11 filling elements of 1
12 storage device for 9 or 10
13 position of use of 9 or 10
14 rest position of 9 or 10
15 gripping region of 9 or 10
16 insertion or receiving opening in 12
17 casing/housing of 1

1-12. (canceled)

13. An apparatus comprising a container treatment device, said container treatment device comprising a container-feeding unit, a container-removing unit, a feed line for a product, and a cleaning device comprising at least one of a flushing device for cleaning an exterior surface using a cleaning fluid and an additional tool that can be removed from a storage device by said cleaning device and that can be brought to a position of use and returned to said storage device after use by said cleaning device.

14. The apparatus of claim 13, wherein said additional tool is configured as a rinsing cap that can be connected to said cleaning device.

15. The apparatus of claim 13, further comprising a drive and support rail for said cleaning device, and a robot that brings said additional tool into a position of use.

16. The apparatus of claim 13, further comprising a drive and support rail for said cleaning device, and a robot that brings said additional tool, which is configured as a rinsing cap, into a position of use.

17. The apparatus of claim 13, wherein said cleaning device comprises one of a robot and a robot arm that comprises said flushing device, and one of a gripper and holder arranged on said one of a robot and a robot arm for bringing said additional tool into said position of use.

18. The apparatus of claim 13, wherein said storage device comprises a vertical outer wall in a region of a casing of said container treatment device.

19. The apparatus of claim 13, wherein said storage device comprises a rinsing cap magazine formed from one of a steel sheet and a plastic panel in which insertion openings are formed to enable said additional tool to be inserted into and removed from said storage device.

20. The apparatus of claim 13, wherein at least one of a tool change, and a pick-up and drop-off of said additional tool takes place automatically.

21. The apparatus of claim 13, wherein said cleaning device is configured to clean said additional tool using said flushing device.

22. The apparatus of claim 13, wherein said additional tool comprises a gripping region for pick-up by said cleaning device.

23. The apparatus of claim 13, wherein said additional tool is configured to connect to said cleaning device by force fit.

24. The apparatus of claim 13, wherein said additional tool is configured to connect to said cleaning device by suction.

25. The apparatus of claim 13, wherein said additional tool is configured as an inspection unit that can be connected to said cleaning device.

26. The apparatus of claim 13, wherein said cleaning device comprises a circumferential track comprising a rest area in which said additional tool is stored on a storage device.

27. The apparatus of claim 13, wherein said additional tool is configured as an inspection unit that can be connected to said cleaning device, and wherein said cleaning device comprises a circumferential track comprising a rest area in which said additional tool is stored on a storage device.
